(19) United States
(12) Patent Application Publication
(10) Pub. No.: US 2018/0307384 A1
(43) Pub. Date: Oct. 25, 2018

(54) WORKFLOW POLICY INTERFACE

(71) Applicant: Cisco Technology, Inc., San Jose, CA (US)

(72) Inventors: Daniel Garrison, San Jose, CA (US); Brian Sarbin, Santa Clara, CA (US)

(21) Appl. No.: 15/849,719

(22) Filed: Dec. 21, 2017

Related U.S. Application Data
(60) Provisional application No. 62/488,885, filed on Apr. 24, 2017.

(51) Int. Cl. G06F 3/0482; G06F 3/0484

(52) U.S. Cl. CPC G06F 3/0482; H04L 12/64; G06F 3/04847

(57) ABSTRACT

In one embodiment, a system includes: a processor, a display screen, and a user interface (UI) application to be executed by the processor and operative: to present policy attributes in a UI with interactive tradeoff analysis on the display screen, where the policy attributes are associated with a network workflow structure, and the interactive tradeoff analysis includes constraint-based optimization of a workflow response, and to dynamically apply said policy attributes to instantiation and deployment of networked resources associated with the network workflow structure.

### RELATED APPLICATION INFORMATION

The present application claims the benefit of priority from U.S. Provisional Patent Application, Ser. No. 62/488,885, filed on Apr. 24, 2017.

### TECHNICAL FIELD

The present invention generally relates to providing a user interface for modeling network resource usage.

### BACKGROUND

Current trends in networks include moving away from the installation of on-site hardware and appliances in favor of virtualization, cloud computing, hybrid workloads, and model-driven networking. Such trends have created new possibilities for creating and deploying dynamic workloads both on-site and in the cloud.

### BRIEF DESCRIPTIONS OF THE DRAWINGS

The present invention will be understood and appreciated more fully from the following detailed description, taken in conjunction with the drawings in which:

FIG. 1 is a schematic illustration of a tiered, network deployment policy optimization architecture constructed and operative in accordance with embodiments described herein;

FIG. 2 is a partly pictorial, partly schematic illustration of the components of an exemplary interactive policy visualization FIG. 1;

FIGS. 3-5 are pictorial illustrations of exemplary user interface for managing network resource allocation, constructed and operative in accordance with embodiments described herein;

FIGS. 6-14 are pictorial illustrations of an alternative exemplary user interface for managing network resource allocation, constructed and operative in accordance with embodiments described herein;

FIG. 15 is a schematic illustration of a computing device operative to present the exemplary user interfaces of FIGS. 3-14;

FIG. 16 is a flowchart of an exemplary network resource allocation process to be performed by the computing device of FIG. 15; and

FIGS. 17A, 17B, 18A, 18B, 18C, and 19 are pictorial illustrations of interactive multivariate graphs to be alternatively used to present the policy attributes in the exemplary embodiments of FIGS. 3-16.

### DESCRIPTION OF EXAMPLE EMBODIMENTS

### Overview

A system includes: a processor, a display screen, and a user interface (UI) application to be executed by the processor and operative: to present policy attributes in a UI with interactive tradeoff analysis on the display screen, where the policy attributes are associated with a network workflow structure, and the interactive tradeoff analysis includes constraint-based optimization of a workflow response, and to dynamically apply said policy attributes to instantiation and deployment of networked resources associated with the network workflow structure.

A method for providing hybrid cloud network resource allocation is implemented on at least one computing device and includes: extracting attribute policies from a network work How structure, presenting the attribute policies in a user interface with interactive tradeoff analysis, where the interactive tradeoff analysis includes constraint-based optimization of a workflow response, and dynamically applying the attribute policies to instantiation and deployment of a network associated with the network workflow structure.

### Description

Service and container orchestration solutions as well as cloud platform solutions are known in the art. However, such solutions typically lack a user interface for exploring and/or optimizing policy tradeoffs for the definition and management of hybrid cloud workflows for actual implementation in the field. Accordingly, users of such solutions typically configure hybrid cloud deployments at a low level of detail and without real-time visibility of tradeoffs involved in policy decisions, thereby resulting in relatively lengthy and error-prone deployments and/or non-optimal service configurations that may not necessarily meet the users' needs.

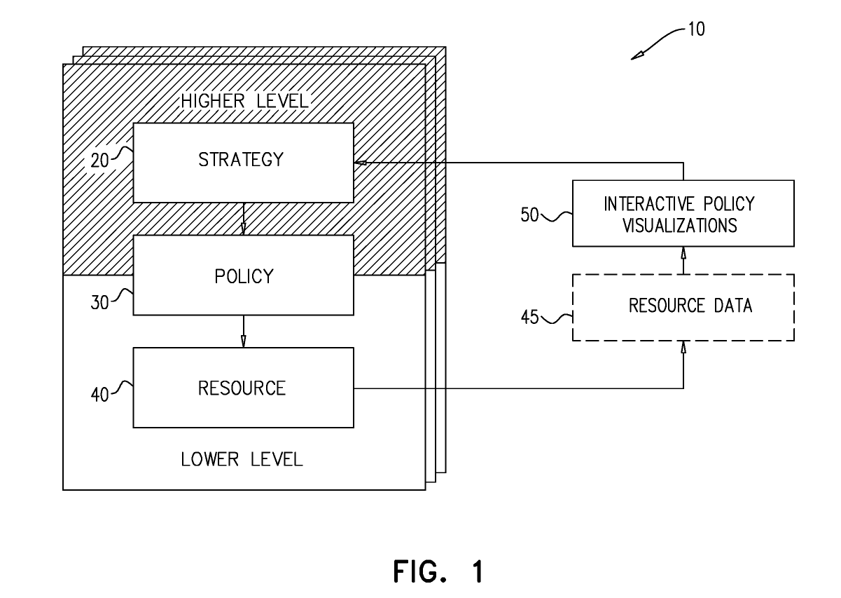

Reference is now made to FIG. 1 which is a schematic illustration of a tiered, network deployment policy optimization architecture 10, constructed and operative in accordance with embodiments described herein. Similar to traditional deployment architectures, architecture 10 is depicted as comprising a top-down flow, comprising strategy 20 which is interpreted as one or more policies 30 and then applied to one or more resources 40 which are allocated to instantiate a network according to policies 30. It will be appreciated that strategy 20 may be one or more higher level, broadly defined, business-based objectives, whereas resources 40 may be lower level, specific network resources allocated to realize the objective(s) of strategy 20. Architecture 10 also comprises a visual feedback loop implemented using interactive policy visualizations 50 based on resource data 45 according to allocated resources 40, thereby providing an interactive tool for optimizing a given network's deployment.

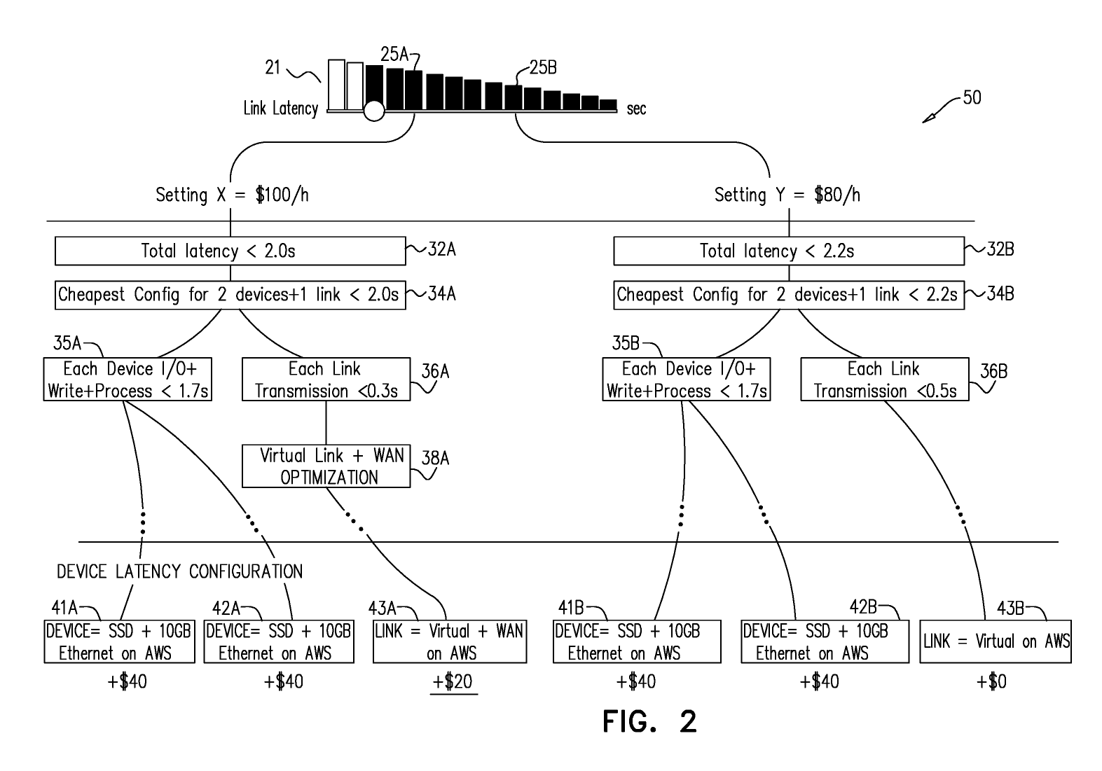

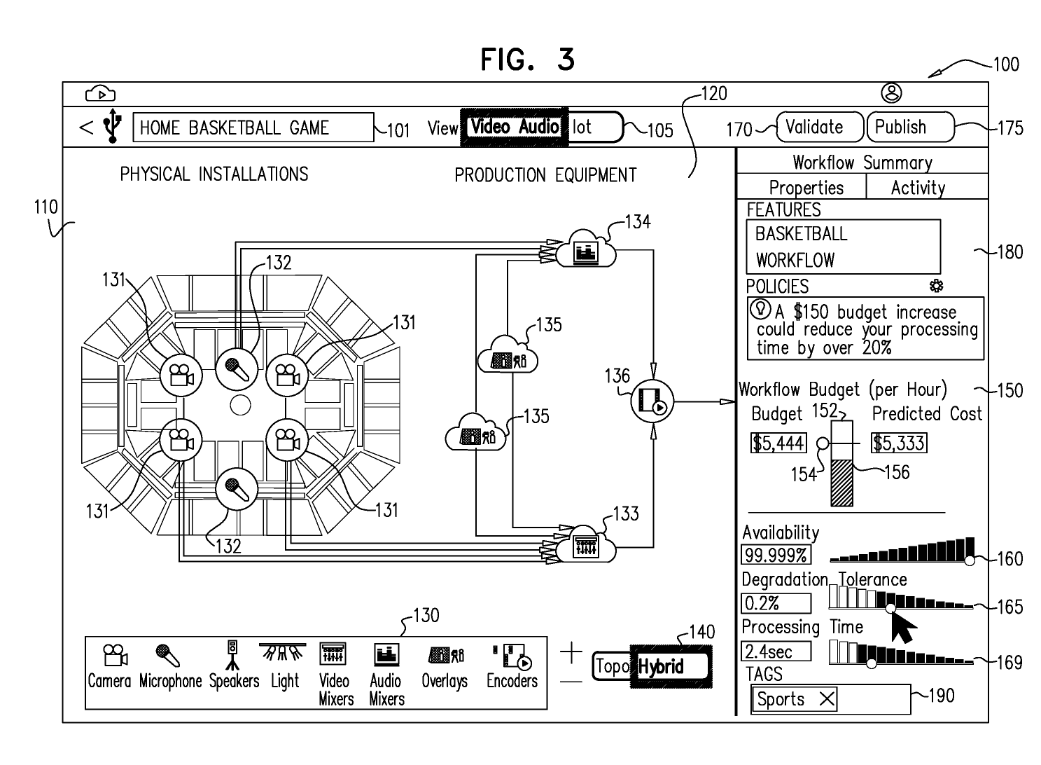

FIG. 2, to which reference is now made, depicts components of an exemplary interactive policy visualization 50. For example, strategy 20 (FIG. 1) may include an objective for link latency in a deployed network. Interactive policy visualization 50 may therefore comprise a link latency interactive slider 21 where different x-axis values map to different policies 30 (FIG. 1) which have measurable link latencies, as well as associated constraint values (e.g. cost, represented on the y-axis). For example, as depicted in FIG. 2, setting 25A may indicate an objective of total latency being less than two seconds which may be constrained by a budget of $100. Similarly, setting 25B may indicate an objective of total latency less than 2.2 seconds which may be constrained by a budget of $80. It will be appreciated that in the exemplary embodiment of Fig 3, the budgets may be absolute, periodic (e.g., hourly, daily, weekly, etc.), and/or a combination thereof.

Settings 25A and 25B may be interpreted as a series of progressively more specific, tiered policies. For example, policy 32A may be a broadly defined policy of total latency being less than 2.0 seconds: “Total latency<2.0s.” Policy 34A is a more specifically detailed policy which accounts for two different factors in total latency: device latency and link latency: “Cheapest config for 2 devices+1 link<2.0s.” It will be appreciated that in the network to be deployed in the exemplary embodiment of FIG. 2 there may be two network devices.

Policy 34A may be more specifically detailed in policy 35A: “Each Device I/O+Write+Process<1.7s;” and policy 36A: “Each link Transmission<0.3 sec.” Policy 36A may be ever more specifically detailed in policy <8A: “Virtual Link+WAN OPTIMIZATION.” Policies 35A and 38A may be used to allocate network resources 41A, 42A, and 43A. As depicted in FIG. 2, resources 41A and 42A may both be associated with a cost of $40, and resource 43A may be associated with a cost of $20, such that the total allocation of resources is within the $100 budget constraint for setting 25A. It will be appreciated that network resources 41A, 42A, and 43A as depicted in interactive policy visualization 50 are exemplary; the embodiments described herein are not limited by a specific technology or provider for the indicated network resources.

Similar to policy 32A, policy 32B may be a broadly defined policy of total latency being less than 2.2 seconds: “Total latency<2.2s.” Similar to policy 34A, policy 34B is a more specifically detailed policy which accounts for two different factors in total latency: device latency and link latency: “Cheapest config for 2 devices+1 link<2.2s.” Policy 35B provides specific details for the devices addressed by policy 34B, and is similar to policy 35A. Policy 36B, however, differs from policy 36A in that a greater link latency is tolerated: “Each link Transmission<0.5s.” It will be appreciated that there are fewer tiers of policies for setting 25B than for setting 25A, reflecting a greater tolerance for total latency, i.e., 2.0s vis-a-vis 2.2s. It will be appreciated that the number of tiers for each setting 25 may vary depending on implementation requirements.

Policies 35B and 36B may be used to allocate network resources 41B, 42B, and 43B. Similar to resources 41A and 42A, resources 41B and 42B may both be associated with a cost of $40. However, due to the greater tolerance for link latency expressed by policy 36B, unlike resource 43A, resource 43B may be associated with a cost of $0 (i.e. no WAN optimization needed), such that the total allocation of resources is within the $80 budget constraint for setting 25B.

It will be appreciated that the number of x-axis values in interactive policy slider 21 may be statically defined policy tiers or be dynamically defined policy tiers based on a number of factors, including the addition of or reduction of network features or the availability of devices or resources at a given point in time.

Reference is now made to FIG. 3 which is a pictorial illustration of an exemplary user interface 100 for managing network resource allocation, constructed and operative in accordance with embodiments described herein. In accordance with embodiments described herein, user interface 100 may be provided to present policies describing system and business constraints together in ways that may allow users to visually manipulate, explore, and optimize their decision-making in real-time.

User interface (UI) 100 is a graphical representation of an exemplary hybrid environment for a sports content provider system. UI 100 comprises representation of both physical installations 110 and production equipment 120. In accordance with the exemplary embodiment of FIG. 3, physical installations 110 may represent a basketball arena, and cameras 131 and microphones 132 may represent physical resources deployed in the arena to facilitate a broadcast of a basketball game as indicated in workflow title 101. Video mixer 133, audio mixer 134 overlays 135 and encoder 136 may represent virtual resources, typically, although not necessarily, located on servers in a cloud environment, on-premises facilities, and/or a co-located data center. Such virtual resources may not necessarily be physically controlled by a user of UI 100, e.g., in the exemplary embodiment of FIG. 3 they may not be located within the basketball arena of physical installations 110. These virtual resources may be provided on a per-component basis and/or as a service by an external entity and may be deployed within the context of production equipment 120 to produce and provide a broadcast of a basketball game based on inputs received from physical installations 110. It will be appreciated that other physical and/or virtual resources may be represented as well, as indicated in resource bar 130. It will be appreciated that as indicated in resource view selector 105, deployed video and audio resources are shown in UI 100; in other exemplary embodiments, Internet of things (IoT) resources may be shown as well.

UI 100 comprises interactive visualizations that are presented for a number of policy attributes associated with the production and provision of a basketball game broadcast; for example, availability policy attribute 160, degradation tolerance policy attribute 165, and processing time policy attribute 169. Each of these policy attributes may be composed of an input field/slider and a graph component, where the slider may function in generally the same manner as interactive policy slider 21 (FIG. 2). It will be appreciated that for all of these attributes, the input field text and slider position may correspond to the same value, and manipulating one may update the other in real-time.

For policy attributes 160, 165 and 169, the slider along the bottom of the graph represents a range of values which may be available In the deployment environment for the given policy attribute at a given time, and the bar heights on the y-axis of the slider represent a constraint associated with each of those values (e.g., predicted cost in the deployment environment). The values for policy attributes 160, 165, and 169 may be derived from an inventory of available resource configurations including, but not limited to, element size or element model version, or by adding “under-the-hood” inline elements. For example, in processing time policy attribute 169, cost values may be derived based on configuration characteristics of elements, e.g. video mixer 133: based on model size, based on different vendor models, or by adding a WAN optimization node between adjacent elements to reduce latency. In general, graph values may differ across policy attributes both in scale and in count, based on the element characteristics from which the graph values are derived and the available options in the deployment environment.

UI 100 also comprises budget constraint policy 150. For a given policy attribute (e.g.. 160, 165,, or 169), the shading of the associated graph's bars may correspond to those values which are possible or not possible within the constraints of budget constraint policy 150, based on the current values of all other policy attributes.

As depicted in FIG. 3, for budget constraint policy 150, a single bar visualization may be used to represent the maximum possible cost (bar height 152), specified budget (slider position 154), and current estimated cost (filled area 156 based on summing costs of other attribute values). For example, as depicted, the workflow budget constraint may be set at $5,444, whereas the current predicted cost may be $5,333.

UI 100 may also comprise validate button 170, publish button 175 and feature description 180. Selection of validate button 170 (e.g., by clicking on it) may activate autonomous validation of the overall deployment represented in UI 100. Selection of publish button 175 may propagate the deployment to the underlying allocation systems. Feature description 180 may be used to enter comments or notes for the currently open version of UI 100, i.e., for a “home basketball game”, as per workflow title 101.

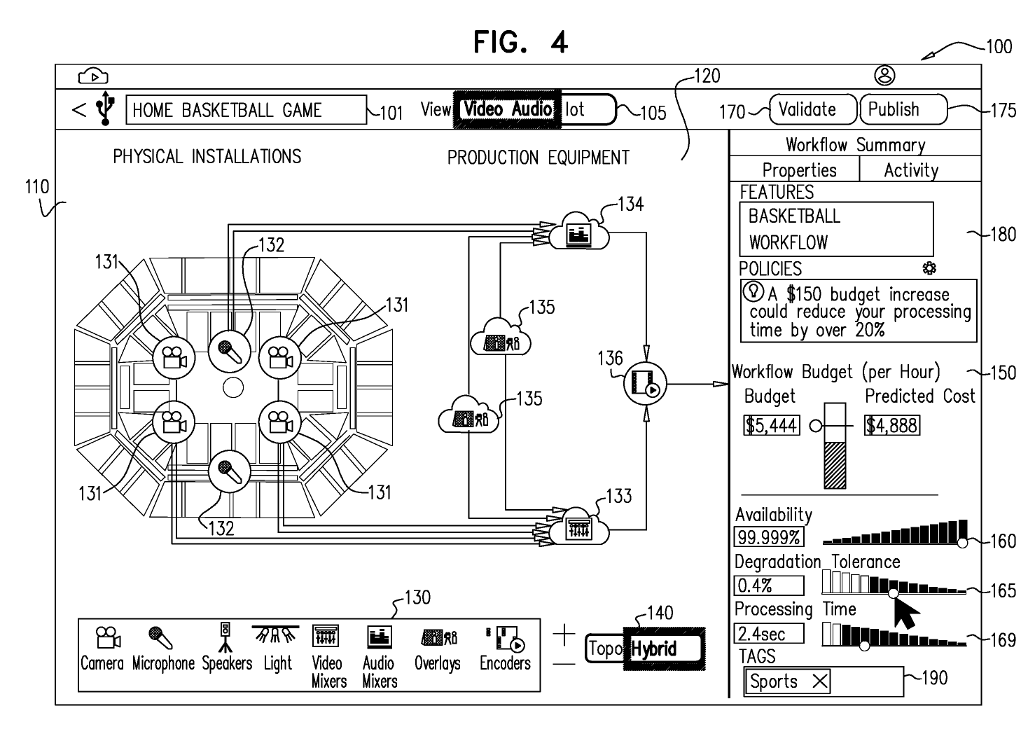

Reference is now made to FIG. 4 which represents another view of UI 100 from FIG. 3; similar reference numerals refer to similar elements. As a user manipulates the value of a given policy attribute (e.g. degradation tolerance policy attribute 165), either by entering a value in an associated input field or by moving an associated slider, the predicted cost within the budget constraint policy 150 may update in response, as may the shades of the cost bars (representing the constraint) on the other policy attributes (e.g. 160 and 169), thereby providing the user with a visual representation of the corresponding tradeoffs. The user may therefore make several such adjustments in an iterative process in order to optimize policy choices in real-time.

As depicted in FIG. 4, the user may have adjusted the slider (see arrow) to increase degradation tolerance attribute policy 165 to a larger value (i.e., from .2% to .4%, which may be less costly); as a real-time response, the total predicted cost in the budget attribute decreases (to $4,888 in FIG. 4 from $5,333 in FIG. 3), and an additional bar in processing time attribute policy 169 may become shaded to indicate that the associated value represented by the additional bar is now a viable choice. Accordingly, by using such dynamic, interactive visualization of policy attributes and their effects, the user may immediately answer questions such as “If I raise my degradation tolerance by this much, how much would I save, or by how much could I now lower my processing time instead?”

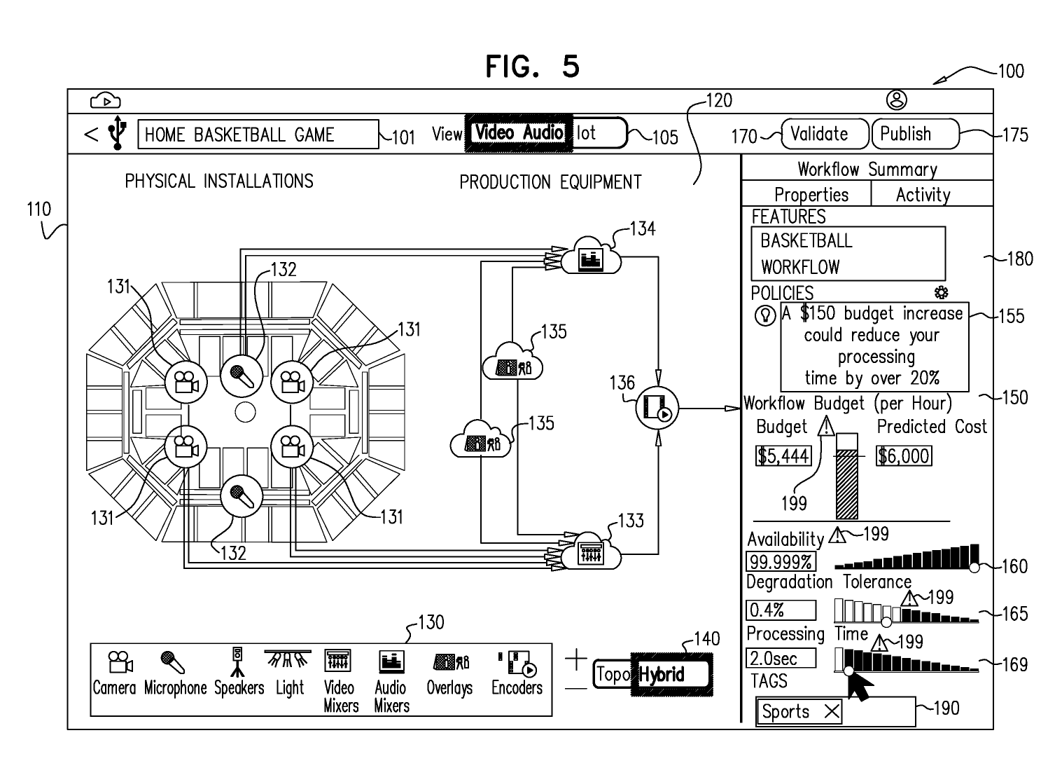

Reference is now made to FIG. 5 which represents another view of UI 100 from FIGS. 3 and 4; similar reference numerals refer to similar elements. It will be appreciated that if the user selects a value for one or more policy attributes, thereby causing his total predicted cost to exceed the budget as set in budget constraint policy 150, an associated warning state may be immediately reflected in the visualization of UI 100. For example, if the user lowers processing time attribute policy 169 (see arrow) to a value with an excessively high cost, the predicted total cost in budget constraint policy 150 may exceed the budget constraint value (e.g., $6,000>$5,444). Each of the other attributes policies (e.g., 160 and 165) may then reflect the warning states of their current values, and enable the user to visualize how much adjustment is needed on the value of the other attribute policies to bring the overall policy back into an acceptable state, for example, as shown in FIG. 5, warning signals 199 may be displayed next to budget constraint policy 150 and/or attribute policies 160 and 165. Alternatively, or in addition, a different color (e.g., yellow, to indicate a warning) may be used in the display of some, or all, of the graphical representation of budget constraint policy 150 and/or attribute policies 160 and 165. The user may therefore be able to understand in real-time how much adjustment is needed and make the appropriate tradeoffs for the desired policy (e.g. one or more of the following: raising the budget, raising degradation tolerance, lowering availability requirements, etc.), rather than modifying the underlying element configurations in a haphazard fashion to achieve the desired result without real-time visualization of the impact of each modification.

In accordance with an embodiment described herein, a contextual insight banner 155 may be included with budget constraint policy 150 that may present relevant “what if” scenarios to the user, providing suggestions for optimizing policy decisions. Based on a current state of the policy settings, one or more manually created or algorithmically generated recommendations may be presented which describe possible tradeoffs in the format of <marginal amount of attribute A> <affect> <marginal amount of attribute B>. For example, a possible contextual insight banner 155 may be provided with the following text: “A $150 budget increase could reduce your processing time by over 20%.” Such insights may help to further elucidate optimizations and tradeoffs that are possible as the user interactively evaluates real-time policy decisions through directly manipulating and affecting the linked policy attributes. It will be appreciated that the embodiment; described herein may support other formats for contextual insight banner 155, with more or fewer variables.

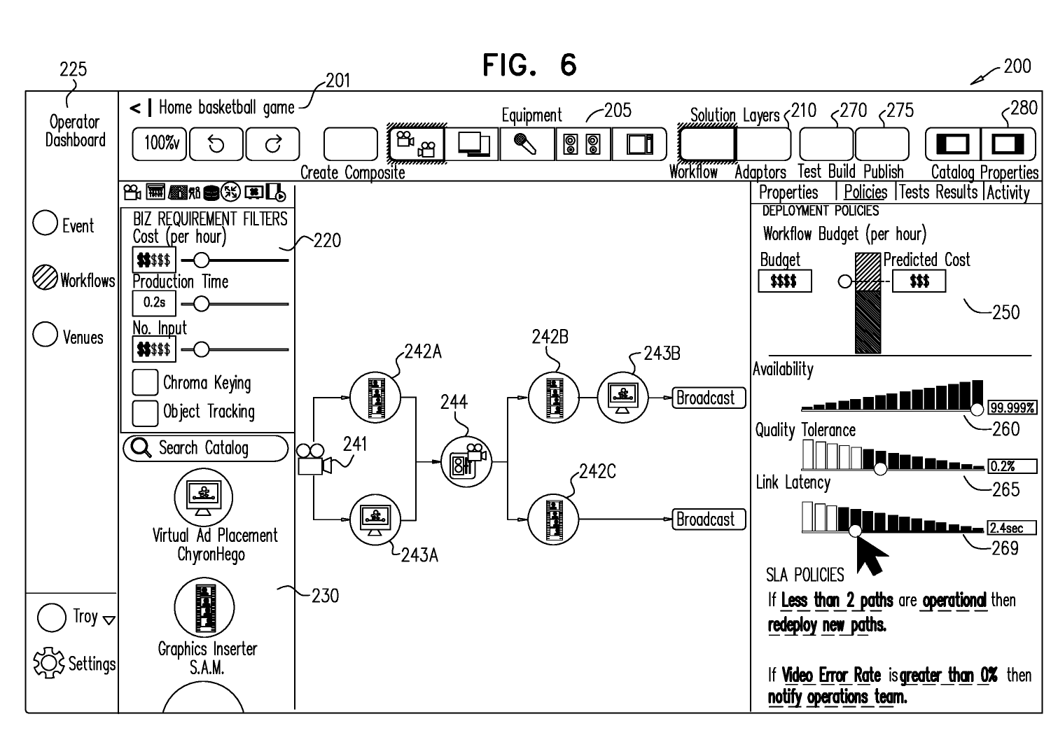

Reference is now made to FIGS. 6-14 which are pictorial illustrations of an alternative exemplary user interface (UI) 200 for managing network resource allocation, conquered and operative in accordance with embodiments described herein. As depicted in FIG. 6, UI 200 may provide an alternative visualization of the “home basketball game”, as per workflow title 201. UI 200 may be configured to present workflow and/or adapter components in accordance with budget constraint policy 250, and attribute policies 260, 265, and 269 for availability, quality tolerance, and link latency. It will be appreciated that budget constraint policy 250, and attribute policies 260, 265, and 269 may be generally similar to element 150, 160, 165, and 169 of FIGS. 3-5, respectively.

Operator dashboard 225 may be employed to toggle between different possible representations of network resource allocation, e.g., as an event, workflows, or venue. Business requirement filters 220 may provide an optional filtering mechanism for selecting items in catalog 230. For example, the exemplary workflow view presented in FIG. 6 may include one or more items of equipment 205, e.g., camera 241, in addition to virtual resources available in catalog 230 such as, for example, graphics servers 242A-C, virtual overlay inserters 243A and 243B, master output switcher 244, etc. UI 200 may also comprise test build button 270 and publish button 275 which are generally similar to buttons 170 and 175 of FIGS. 3-5.

It will be appreciated that the embodiments described herein are not limited specifically to the inclusion of the UI features presented in the exemplary embodiments of FIGS. 3-5 and/or FIGS. 6-14. The embodiments described herein may be implemented with or without one or more of the UI features depicted herein such as, for example, business requirement filters 220, operator dashboard 225, catalog 230, etc.

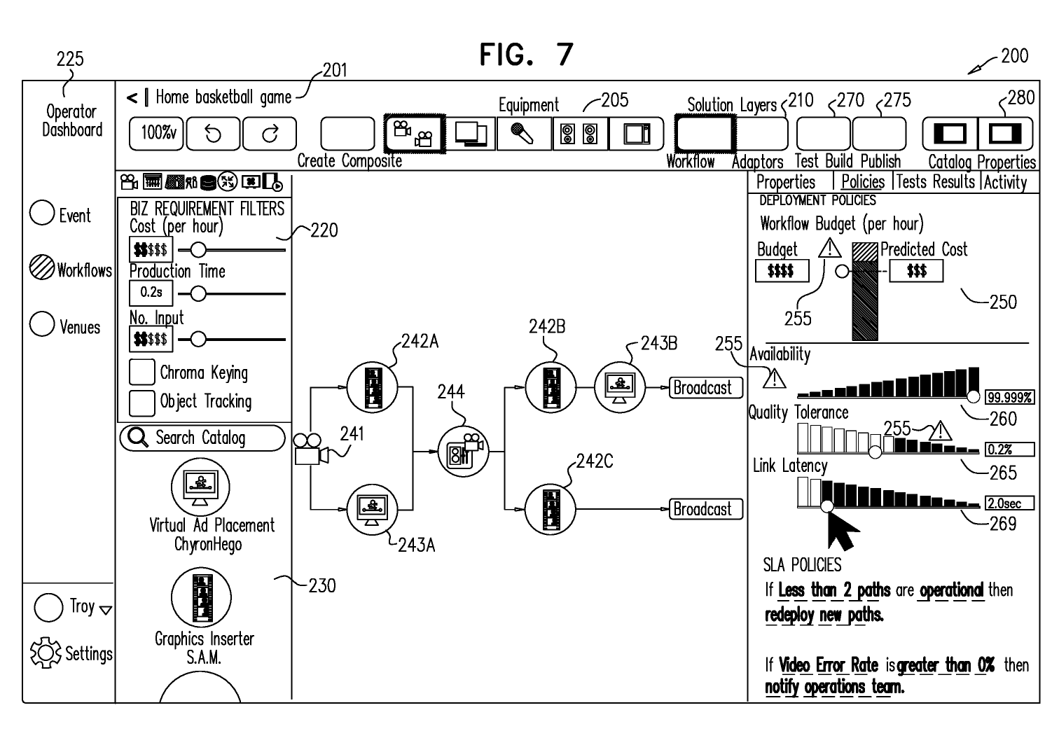

In accordance with an exemplary embodiment, the user may select (see arrow) to adjust latency attribute policy 269. As illustrated in FIG. 7, lowering the policy for latency from 2.4 to 2.0 may result in the predicted cost in budget constraint policy 250 exceeding the budget constraint.

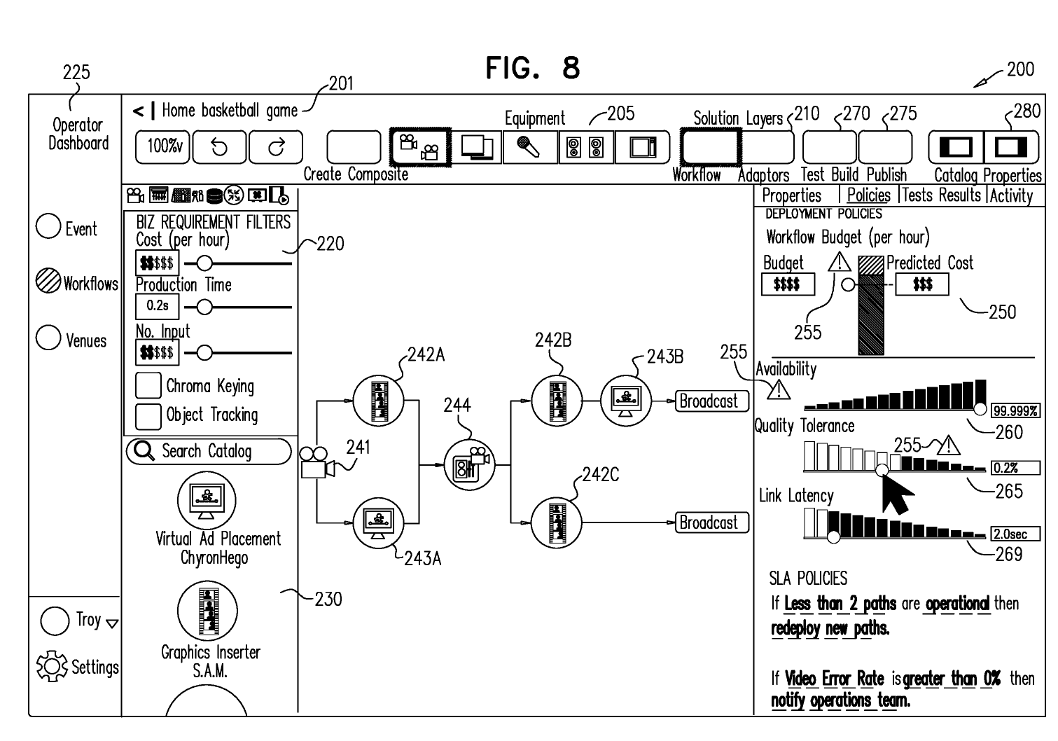

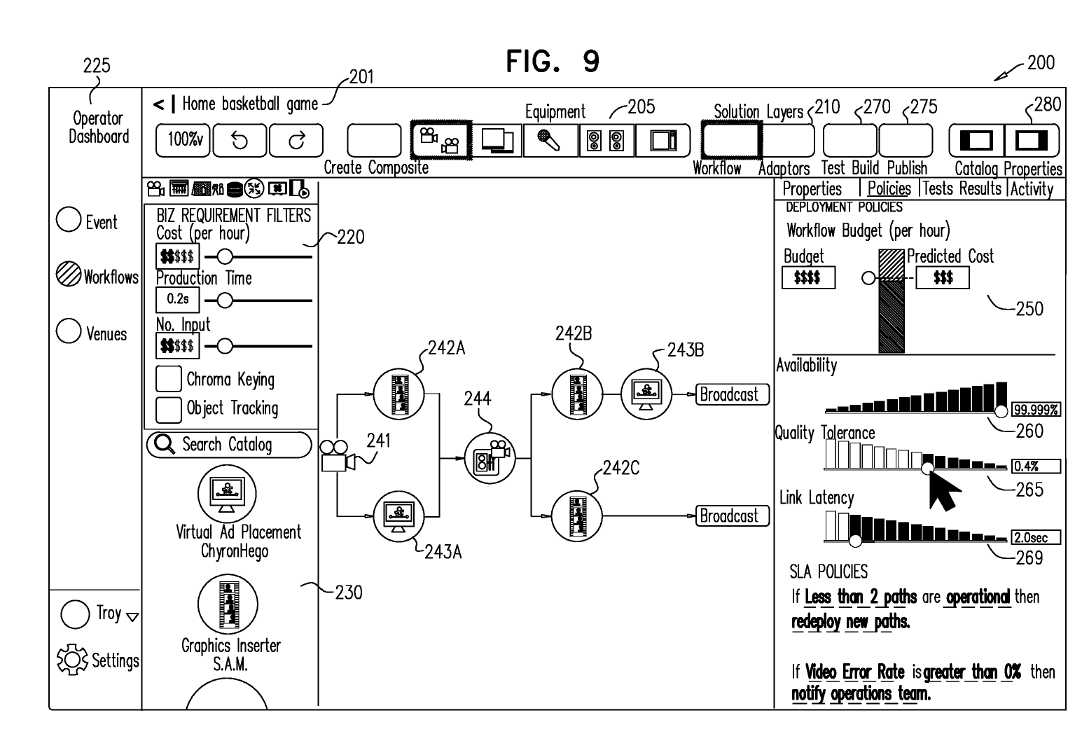

As depicted in FIG. 8, in response, the user may then select (see arrow) to adjust quality tolerance attribute policy 265. As illustrated in FIG. 9, raising the policy for quality tolerance may reduce the predicted cost component in budget constraint policy 250 in order to comply with the budget constraint.

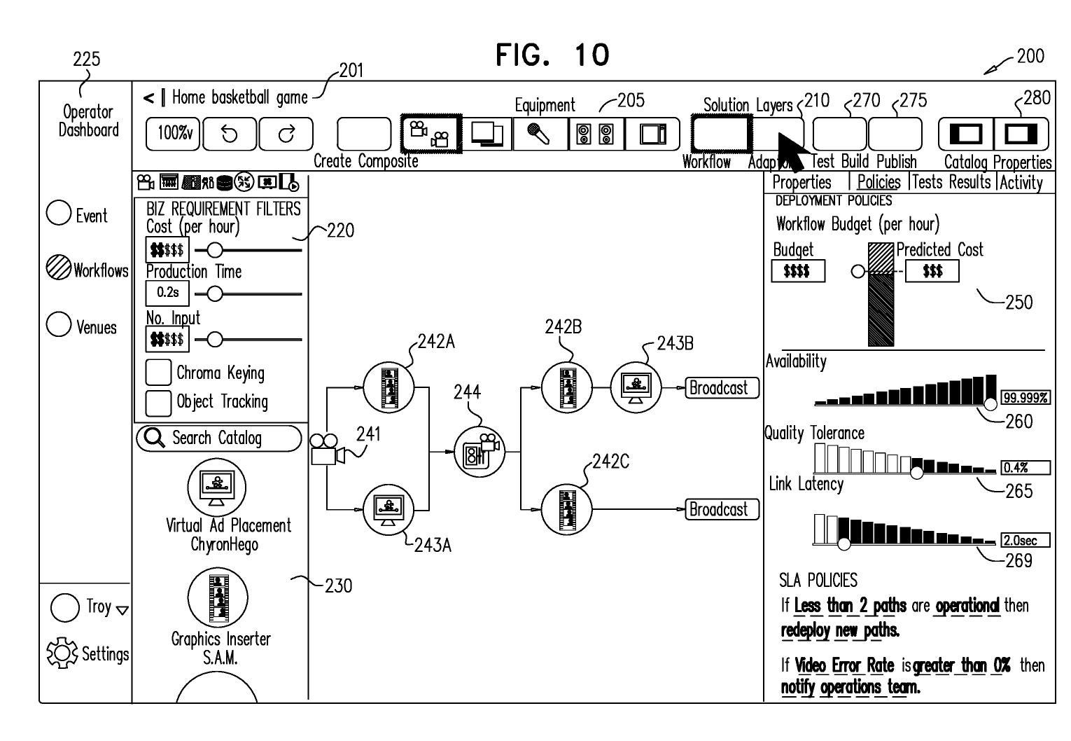

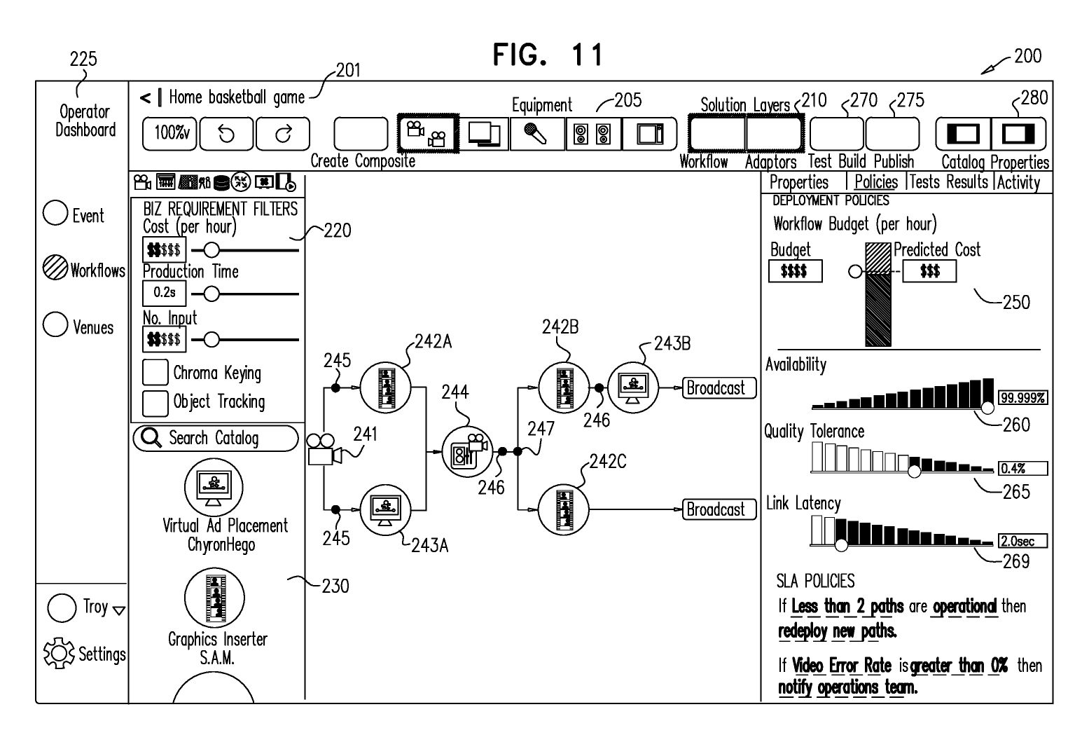

As depicted in FIG. 10, the user may select (see arrow) to also show adapters from solution layers 210. As illustrated in FIG. 11, UI 200 now also shows SDI to IP adapters 245, as well as VPP adapters 246.

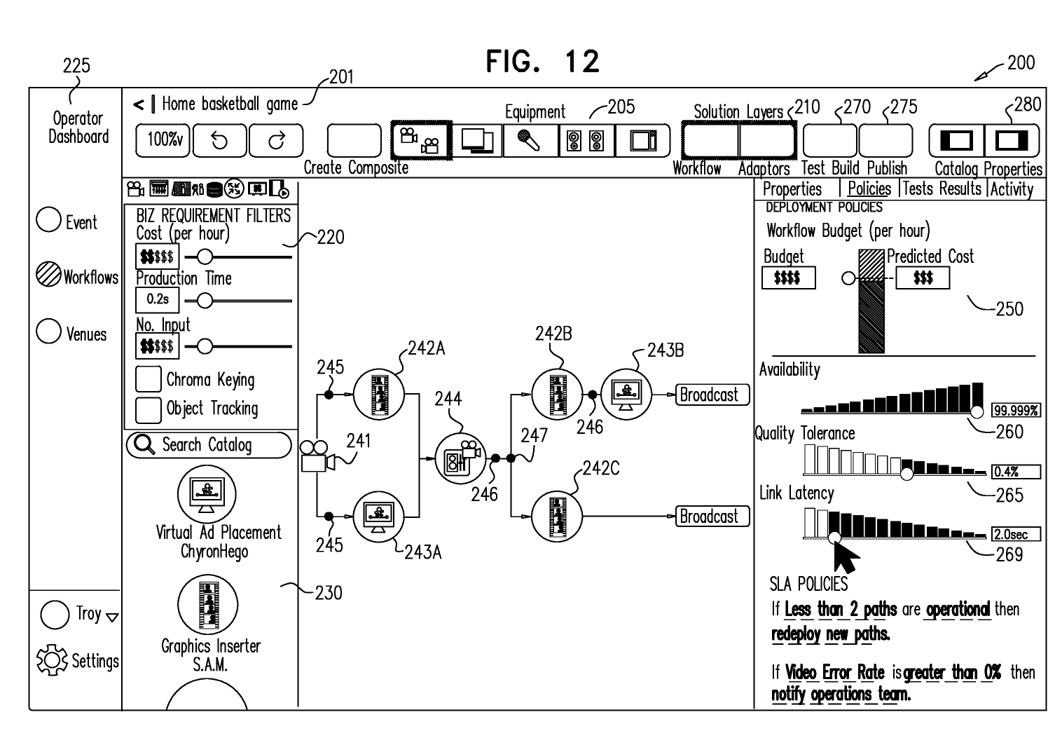

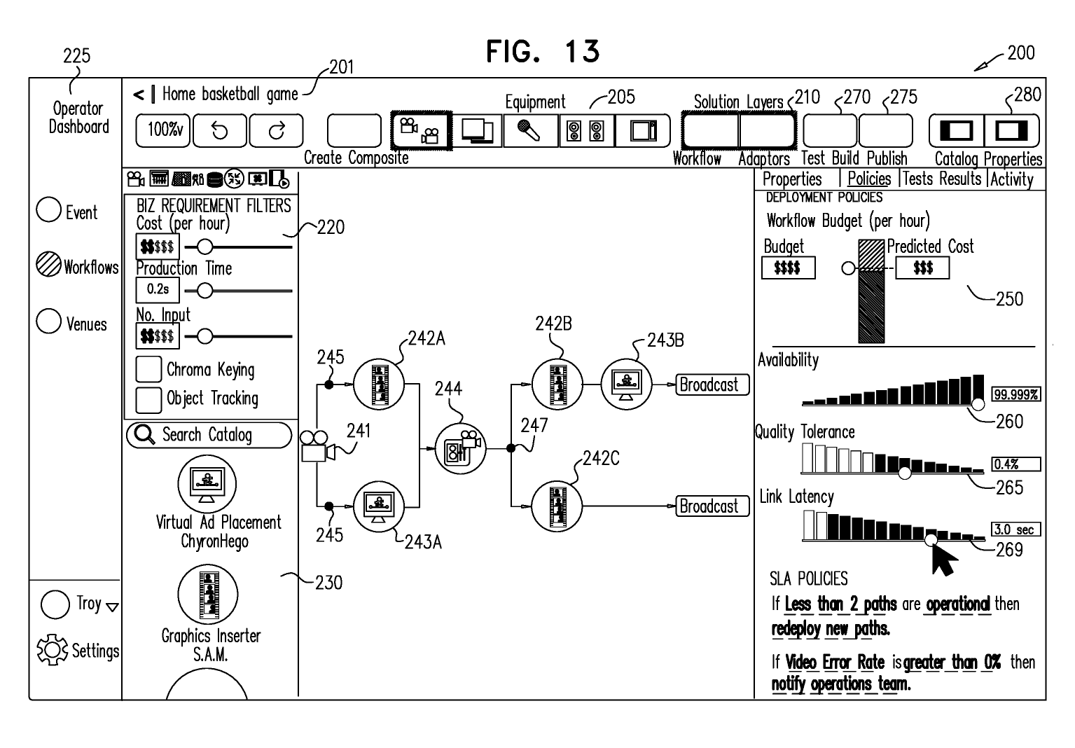

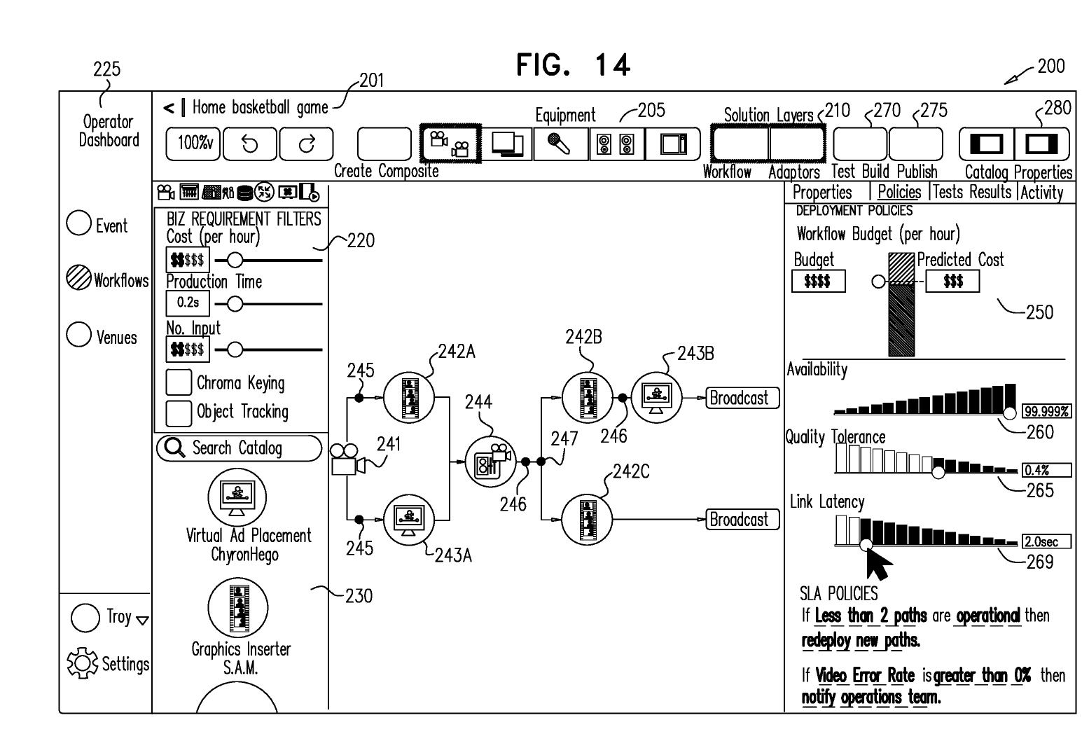

As depicted in FIG. 12, the user may select (see arrow) to readjust link latency attribute policy 269. As illustrated in FIG. 13, such a relaxation in requirements for link latency may eliminated the need for VPPs 246 which may no longer be shown in UI 200. Restoring link latency attribute policy 269 to its previous value may necessitate the return of VPPs 246 to the workflow, as show in FIG. 14. Per the above descriptions, much of the functionality provided by UI 200 may be generally similar to the functionality provided by UI 100. Adjustable budget constraints may be employed to dynamically illustrate resulting changes in a network deployment. However it will be appreciated that in addition to the configuration of existing network nodes as described with respect to UI 100, UI 200 may also facilitate dynamic change of the underlying network structure.

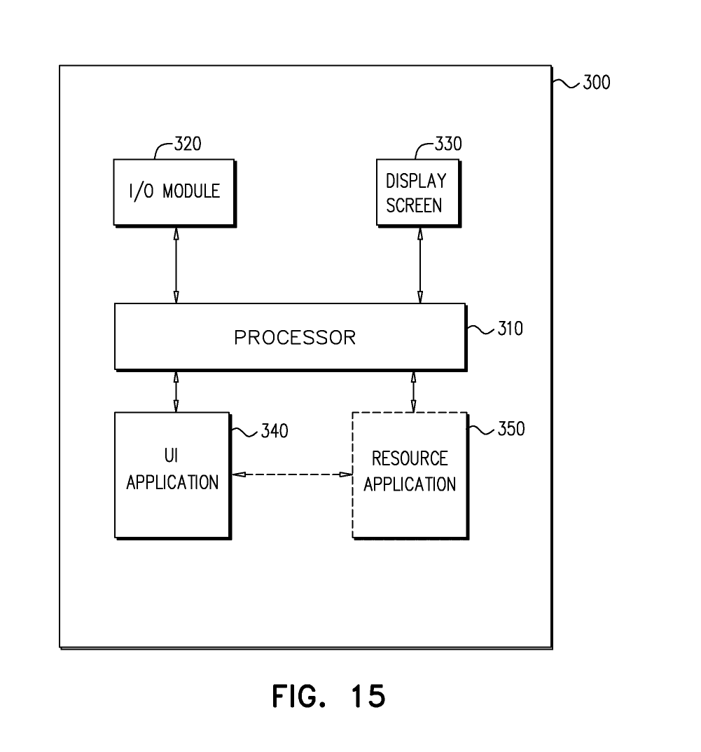

Reference is now made to FIG. 15 which is a schematic illustration of a computing device 300, operative and constructed in accordance with embodiments described herein to provide UIs 100 and 200 as depicted in FIGS. 3-14. Computing device 300 may be any suitable computing device that may support the presentation of UIs 100 and 200. For example, computing device 300 may be implemented as a personal computer, a computer tablet, a dedicated video production device, etc.

Computing device 300 comprises hardware and software components, such as are well-known in the art. Computing device 300 also comprises processor 310, input/output (I/O) module 320, display screen 330 and UI application 340. It will be appreciated that computing device 300 may comprise more than one processor 310. For example, one such processor 310 may be a special purpose processor operative to at least execute UI application 340 to present UI 100 and/or UI 200. Processor 310 may be operative to execute instructions stored in a memory (not shown), such as, for example, UI application 340. I/O module 320 may be any suitable software or hardware component such as a network interface card (NIC), universal serial bus (USB) port, disk reader, modem or transceiver that may be operative to communicate with a virtual or physical resource and/or a virtual or physical resource application (e.g., service and container orchestration applications, or cloud platform applications) over a communications network such as, but not limbed to, the Internet.

Display screen 330 may implemented as an integrated or peripheral component of computing device 300. Display screen 330 may be operative to at least present the visual aspects of UI 100 and/or UI 200 as rendered by UI application 340. In some embodiments, display screen 330 may be implemented as a touchscreen operative to directly receive user input. Alternatively, or in addition, computing device 300 may be implemented with other integrated and/or peripheral input devices, e.g., a keyboard, mouse, joystick, microphone, etc. that may be operative to receive user input via other methods known in the art, such as, for example, keystrokes, mouse clicks, voice commands, etc. UI application 340 may be an application implemented in hardware or software that may be executed by processor 310 in order to at least present UI 100 and/or UI 200 to a user of computing device 300.

It will be appreciated that the embodiments described herein may also support the distribution of the functionality attributed to computing device 300 to multiple such devices. It will similarly be appreciated that in accordance with some embodiments, one or more (physical or virtual) resource applications 350 may be installed on computing device 300.

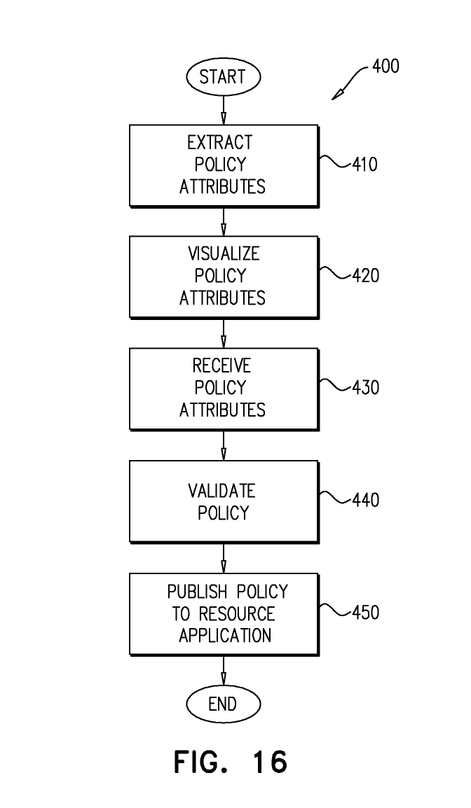

Reference is now made to FIG. 16 which is a flowchart of exemplary network resource allocation process 400 to be performed by the computing device of FIG. 15. UI application 340 may extract policy attributes from the workflow structure represented by physical installations 110 and production equipment 120 (FIGS. 3-5). It will be appreciated that as a baseline, the existence of a workflow structure containing physical and/or virtual elements and their interconnection of links may be assumed. In accordance with some embodiments described herein, UI application 340 may be used to create the workflow structure, but it will be appreciated that such structure may also be received as a given from external sources.

The linked physical and virtual elements that comprise a given workflow may intrinsically have certain characteristics that describe their capabilities, as well as their relationships among one another. When taken together, the commonalities or overlaps across the capabilities of the linked physical and virtual elements may be considered as higher-level characteristics of the workflow as a whole, which may then be presented as policy attributes of the workflow.

For example, in the media content production workflows described in FIGS. 3-14, there are a multiplicity of physical and virtual elements including cameras 131, microphones 132, video mixers 133, audio mixers 134, encoders 136, graphic overlay modules 135, etc., as well as the links between these elements. Based on these elements and their known characteristics, the media production workflow may then be described by policy attributes derived from these characteristics, including cost, availability, video degradation tolerance, and processing time. These policy attributes (e.g., 160, 165, 169) each comprise characteristics from multiple physical/virtual elements; for example, processing time may include both the time it takes a video feed to move from a physical camera (i.e. network latency) and the time it takes a virtual video mixer to process the video feed (i.e. computation time).

These policy attributes may be the building blocks of policy used to instantiate and deploy the workflow in a dynamic, elastic, hybrid physical/virtual environment. UI application 340 may visualize (step 420) these policy attributes as a multivariate, interactive data visualization in which the attributes are linked through a common constraint (i.e. budget constraint policy 150). As the user changes values for a given policy attribute, the corresponding effects on other attributes in light of the constraint are reflected in real-time, enabling the user to quickly and efficiently understand the tradeoffs involved in policy decisions and optimize his choices accordingly.

In the embodiments of FIGS. 3-14, the user may specify and modify values for policy attributes including cost, availability, video degradation tolerance, and processing time. As with many policies, the user may seek to optimize choices in light of certain constraints—to maximize the technical capabilities enabled for his/her business within the bounds of a budget constraint. It will be appreciated that a constraint is not limited to monetary attributes in all embodiments; rather, it may be any limiting attribute whose association may be visualized across other attributes.

UI application 340 may receive (step 430) adjustments to attribute policies from the user in an iterative process. It will be appreciated that steps 420 and 430 may be performed iteratively as the user adjusts policies based on the ensuing changes to the visualization in UI 100 or UI 200.

UI application 340 may validate (step 440) the workflow in terms of one or more of its constraints. For example, the workflow of FIGS. 3-5 may not successfully deploy as long as the predicted cost in budget constraint policy 150 exceeds the budget constraint.

UI application 340 may publish (step 450) the values entered in UI 100 or UI 200 to one or more underlying resource applications 350. Publishing may entail saving the attribute policies configured in UI 100/200, and passing the saved values as input to a resource application, such as, for example, a cloud abstraction platform. When the user chooses to validate or activate a given instance of a workflow, the associated resource application instantiates the underlying workflow elements with characteristics meeting the user's policy requirements, and deploys these elements to cloud and/or on-premise infrastructure. This dynamic instantiation based on the user's policy requirements may be possible because the attribute policies are derived from the characteristics oi a given workflow (in step 410) and the available inventory in a deployment environment.

As various factors (e.g., cloud hosting infrastructure costs) change in an on-demand deployment environment, resource application 350 may be instructed by UI application 340 to dynamically make adjustments to continue meeting the user's policy requirements. These dynamic adjustments may be possible because the set of attribute policies is a holistic representation of the workflow, rather than a one-to-one mapping of discrete elements. These dynamic adjustments may include which device models to instantiate, which clouds to deploy to, and/or which elements to spin up or spin down as the platform reallocates workloads according to the user's policy requirements. Likewise, as elements in the available inventory are added, modified, or removed, a resource application may automatically reallocate components as needed without proactive intervention by the user, as long as the overall policy constraints may still be met.

Based on the changes to the workflow instantiation, any corresponding updates to the policy attribute values may then be reflected in the interactive visualizations in steps 420 and 430, allowing the user to have continual visibility and refine the desired policy requirements as needed in a reactive feedback loop. UI 100/200 may therefore reflect the effect of real-time changes (by the user or in the deployment environment) on the set of derived workflow attributes, allowing users to dynamically make adjustments to optimize against a given constraint.

It will therefore be appreciated that by visualizing values for workflow policy attributes in the context of a constraint, and by visualizing how changes to a given attribute may directly affect tradeoffs against other attributes, UI 100/200 may enable users to define their policies more efficiently, more accurately, and more optimally. This visual tradeoff analysis enables them to more simply and easily achieve the desired business goals.

It will similarly be appreciated that as the user manipulates a given policy attribute, the effects on the overall policy and other policy attributes may be visualized in real-time, creating a tight feedback loop. Insights into error states and policy optimization recommendations may be presented, allowing the user to immediately refine policy decisions without actually instantiating the workflow first. It will also be appreciated that the embodiments described herein may also support other deployment models including, for example, live policy changes on an already deployed and active workflow. UI application 340 may also use different sets of UI controls, such as toggle buttons and/or graph components to reflect the set of policy configurations available in the deployment environments).

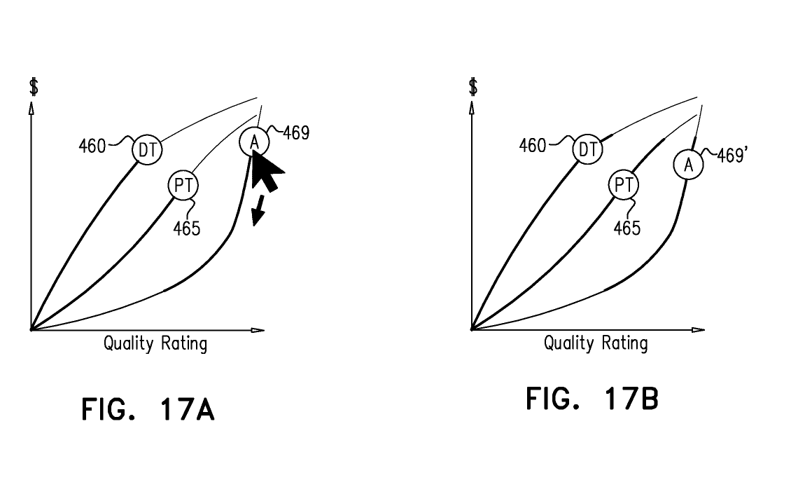

In accordance with some embodiments, UI application 340 may present policy attributes (in addition to, or instead of, policy attributes 160/260, 165/265, and 169/269 as described hereinabove with respect to FIGS. 3-14) as markers on an interactive multivariate graph. For example, as shown in FIGS. 17A and 17B, to which reference is now made, the interactive multivariate graph may plot the domain of attribute values in terms of quality rating for availability 469, degradation tolerance 460, and processing time 465 (respectively labelled in FIGS. 17A and 17B as “A”, “DT”, and “PT”) against a range of constraint values, e.g., cost (labelled in FIGS. 17A and 17B as “$”). In the exemplary embodiment of FIG. 17A, the dark lines on which the indicators are positioned indicate setting flexibility for the associated attribute value. As shown, a user may lower availability 469 in both quality rating and cost by dragging the associated indicator (“A”) downwards along its associated dark line.

As depicted in FIG. 17B, the resulting new seating for availability 469 (herein labelled as 469′) provides increased flexibility for raising the quality rating of processing time 465 and/or degradation tolerance 460 in light of the overall budget constraint. This is illustrated in FIG. 17B by the dark lines now extending past “DT” and “PT”. It will be appreciated that as the attribute and constraint values may be plotted and manipulate along the same graph axes, this embodiment may enable a user to visualize configuration options, intuitively understand the tradeoffs, and optimize policy decisions in real-time.

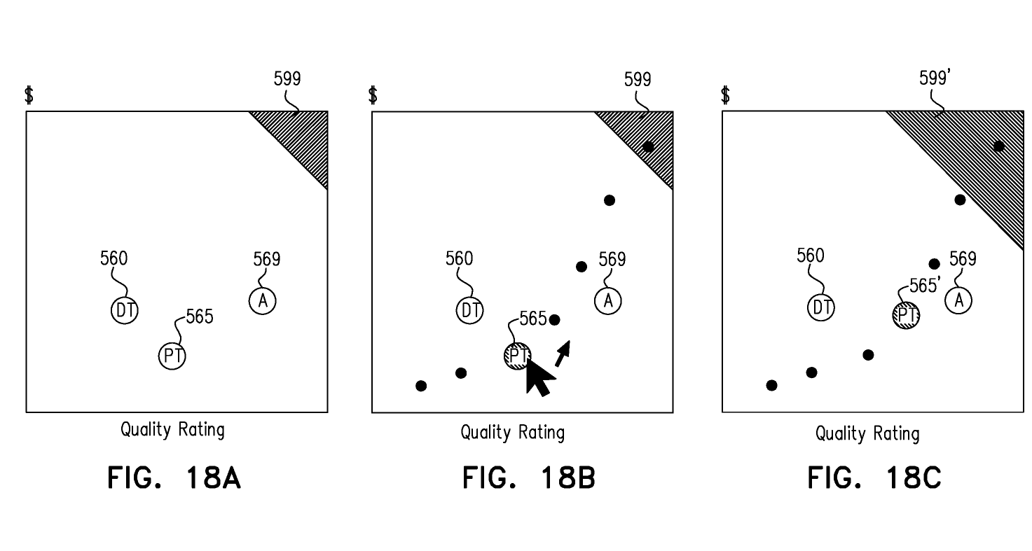

Reference is now made to FIG. 18A. In accordance with other embodiments described herein, UI application 340 may present the policy attributes (e.g., DT 560, PT 565, and A 569) as markers on an interactive scatterplot, which plots the domain of attribute values against the range of constraint values. Infeasible configuration 599 represents points of policy configuration which are infeasible given a current budget constraint As depleted in FIG. 18B, to which reference is now made, a user may select a given policy attribute marker (e.g., PT 565) to adjust the underlying attribute policy. When the policy attribute marker is selected, the possible value/constraint combinations for this policy attribute are highlighted as points on the scatterplot. As shown in FIG. 18C, to which reference is now made, as the user modifies a given policy attribute marker (i.e., PT 565 has been moved to PT 565′), infeasible configuration 599 may update accordingly in real-time (or near real-time), to illustrate an updated region of values (attribute values and constraint values) which are now infeasible in light of the overall budget constraint for the policy. In the interests of clarity of presentation, infeasible configuration 599 may be depicted herein as a contiguous area approximating a neat triangle in the corner of the interactive scatterplot. It will be appreciated that the depiction in FIGS. 18A-18C may be exemplary, in practice, infeasible configuration 599 may alternatively take different shapes and forms depending on givers quality/cost configurations. For example, in some situations, infeasible configuration 599 may have a non-contiguous “jigsaw” shape.

In accordance with other embodiments, UI application 340 may present policy attribute values as adjustable horizontal Hues overlaid over time-series plots of the attributes' actual measured values in an ongoing deployment. In accordance with embodiments described herein, a user may use known UI methods and techniques to set the policy attribute values by adjusting a horizontal line up or down to raise or lower a given policy attribute's value. After a value has been set for a policy attribute, UI application 340 may present an actual usage plot of the resource or target associated with the policy attribute.

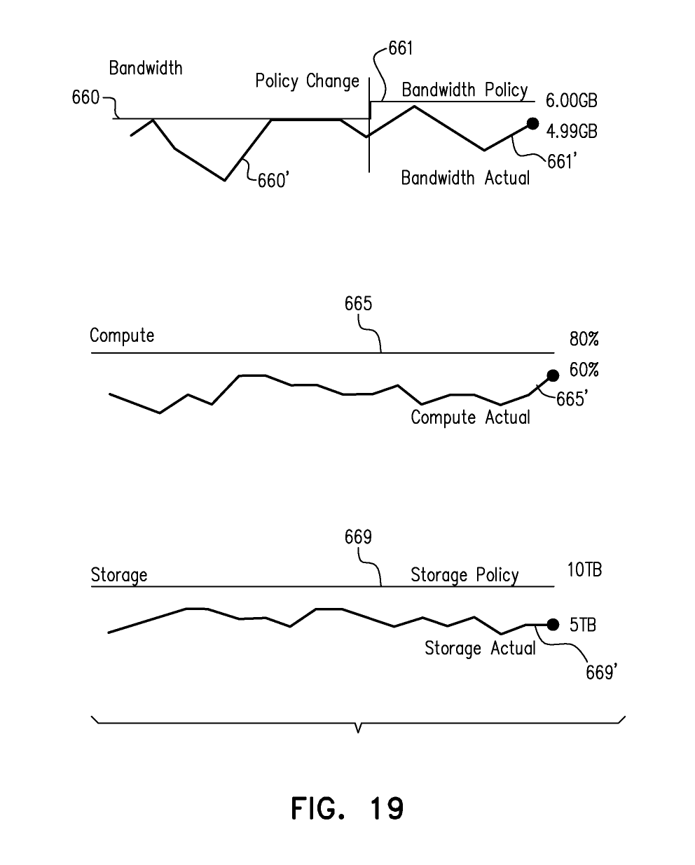

For example, as depicted in FIG. 19 to which reference is now made, UI 100/200 may be implemented with policy attributes such as bandwidth policy attribute 660, compute policy attribute 665, and storage policy attribute 669. As the adjustable horizontal lines associated with policy attributes 660, 665, and 669 are adjusted by a user, UI application 340 may present values for bandwidth actual 660′, compute actual 665′, and storage actual 669′ as a time-series plot to visually present the effects over time of the user input adjustments. In accordance with some embodiments, the policy attributes may also be presented as a time-series plot to more clearly match the presentation of the actual values with the policy attribute in effect over time. For example, bandwidth policy 660 may be adjusted by the user to reflect bandwidth policy 661. Accordingly, bandwidth actual 660′ represents actual bandwidth usage while bandwidth policy attribute 660 was in effect; and bandwidth actual 661′ represents actual bandwidth usage while bandwidth policy attribute 661 was in effect.

It will be appreciated that the user may use known UI gestures and techniques for adjusting policy attributes in the embodiments described herein. For example, the markers, lines, etc. in the embodiments of FIGS. 17-19 may be dragged using a mouse or other pointing device. Alternatively, or in addition, if display screen 330 is implemented with touchscreen functionality, the adjustable horizontal lines may be dragged using one or more fingers or a stylus. Alternatively, or in addition, the markers, lines, etc. may be adjusted using keyboard entry and/or menu selections.

It will also be appreciated that whereas traditional systems may expose predefined building blocks of configuration on an element-by-element basis, such exposure is typically at a lower level than addressed by the embodiments described herein, thereby necessitating frequent updating of multiple related options at a more granular level and obfuscating the connection between technical implementation and business requirements or needs. In contrast, the attribute policies in UI 100/200 are derived from constituent elements and compiled as a holistic representation of the workflow. Users may interactively define the desired output of the system (represented by this set of attribute policies) according to their business needs, and a resource orchestration application (e.g., a cloud abstraction platforms) may create and Instantiate the workflows according to these policies,

Furthermore, policies based on the combination of the constituent elements may simplify aid seduce the work required to instantiate a workflow. Users may specify their end goal via the workflow's policy attributes, abstracting a way from the ever-changing details of the underlying network, compute, storage, and cloud infrastructure that enable she creation and deployment of desired application capabilities. A resource application may then offload the individual element-level deployment and configuration decisions to fit within the constraints of the workflow policy, even as deployment environment characteristics (e.g. cost, inventory, hosting environment, product upgrades, alternative technologies, competing products, vendor pricing) may change dynamically. It will be appreciated that as long as a new (or modified) network component's characteristics may be modeled and measured, the tiered policy system described herein may utilize the component during implementation.

It is appreciated that software components of the present invention may, if desired, be implemented in ROM (read only memory) form. The software components may, generally, be implemented in hardware, if desired, using conventional techniques. It is further appreciated that the software components may be instantiated, for example: as a computer program product or on a tangible medium. In some cases, it may be possible to instantiate the software components as a signal interpretable by an appropriate computer, although such an instantiation may be excluded in certain embodiments of the present invention.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined by the appended claims and equivalents thereof.

What is claimed is:

1. A system instantiated on at least one computing device and comprising:
a processor;
a display screen; and
a user interface (UI) application to be executed by said processor and operative to:
present policy attributes in a UI with interactive tradeoff analysis on said display screen, wherein said policy attributes are associated with a network workflow structure, and said interactive tradeoff analysis includes constraint-based optimization of a workflow response, and
dynamically apply said policy attributes to instantiation and deployment of networked resources associated with said network workflow structure.

2. The system according to claim 1 wherein said UI application is further operative to:
enable setting of at least one policy attribute from said policy attributes by presenting said at least one policy attribute on an interactive slider, wherein said interactive slider is scaled to present a range of selectable settings for said at least one policy attribute.

3. The system according to claim 1 wherein said UI application is further operative to:
enable setting of at least one policy attribute from said policy attributes by presenting said at least one policy attribute as one or more markers on an interactive scatterplot graph, wherein said interactive scatterplot graph plots a domain of attribute values against a range of constraint values, and a section of said interactive scatterplot graph indicates points of policy configuration which are infeasible under a current budget constraint.

4. The system according to claim 1 wherein said UI application is further operative to:
enable setting of at least one policy attribute from said policy attributes by presenting said at least one policy attribute as an adjustable horizontal line representing an associated attribute policy value overlaid on a time-series plot of actual measured values for said at least one policy attribute.

5. The system according to claim 4 wherein said UI application is further operative to:
present said time-series plot of actual measured values in context with a time-series plot of settings for said at least one policy attribute.

6. The system according to claim 1 wherein said network is a hybrid network comprising both physical network resources and virtual network resources, and at least some of said virtual network resources are provided by an external entity via a cloud network.

7. The system according to claim 1 wherein:
said policy attributes are interpreted as a series of progressively more specific, tiered policies; and
at least one network resource is associated with at least one tiered policy from among said series, wherein said UI application is further operative to deploy said at least one network resource according to said at least one tiered policy.

8. The system according to claim 1 wherein said UI application is further operative to:
validate said network workflow structure in terms of one or more constraints; and
upon detecting a non-valid state in said network workflow structure, present said non-valid state contextually in said UI.

9. A method for hybrid cloud resource allocation, the method implemented on at least one computing device and comprising:
extracting policy attributes from a network workflow structure and from component element characteristics;
presenting said policy attributes in a user interface (UI) with graphical interactive tradeoff analysis, wherein said graphical interactive tradeoff analysis includes constraint-based optimization of a workflow response; and
dynamically applying said policy attributes to instantiation and deployment of networked resources associated with said network workflow structure.

10. The method according to claim 9 wherein said constraint-based optimization comprises:
validating said network workflow structure in terms of one or more constraints; and
upon detecting a non-valid state according to said validating, presenting said non-valid state contextually in said UI.

11. The method according to claim 9 wherein said network workflow structure comprises both physical resources and virtual resources.

12. The method according to claim 11 wherein said virtual resources are provided via a cloud network.

13. The method according to claim 9 wherein:
said graphical interactive tradeoff analysis comprises:
presenting at least one policy attribute from said policy attributes, and
detecting a user input for a change to said at least one policy attribute;
said dynamically applying comprises:
applying said at least one policy attribute to instantiation and deployment of said networked resources according to said at least one policy attribute; and
said presenting comprises:
presenting resulting changes to said deployment of said networked resources in real-time, wherein said resulting changes reflect said applying said at least one policy attribute.

14. The method according to claim 13 wherein said changes to said deployment of said networked resources include changes to configuration of at least one network element associated with said network workflow structure.

15. The method according to claim 13 wherein said at least one policy attribute is presented as at least one interactive slider, wherein said at least one interactive slider is scaled to present a range of selectable settings for said at least one policy attribute

16. The method according to claim 13 wherein said at least one policy attribute is presented as at least one marker on an interactive multivariate graph, wherein said interactive multivariate graph presents a plot of a domain of policy attribute values against a range of constraint values.

17. The method according to claim 13 wherein said at least one policy attribute is presented as at least one adjustable horizontal line representing an associated attribute policy value overlaid on a time-series plot of actual measured values for said at least one policy attribute.

18. The method according to claim 9 wherein said dynamically applying comprises:
changing said network workflow structure.

19. The method according to claim 9 and further comprising:
interpreting said policy attributes as a series of progressively more specific, tiered policies; and
associating at least one network resource with at least one tiered policy from among said series, wherein said dynamically applying comprises deploying said at least one network resource according to said at least one tiered policy.

20. A hybrid cloud resource allocation system, the system instantiated on at least one computing device and comprising:
means for presenting policy attributes associated with a network workflow structure in a user interface (UI), said UI providing constraint-based optimization of a workflow response with graphical interactive tradeoff analysis, wherein said graphical interactive tradeoff analysis comprises at least means for detecting a user input for a change to said at least one policy attribute; and
means for dynamically applying said policy attributes to instantiation and deployment of networked resources associated with said network workflow structure according to said at least one policy attribute, wherein said means for presenting also comprise means for presenting resulting changes to said deployment of said networked resources in real-time in response to said dynamically applying.
